(19) United States
(12) Patent Application Publication
(10) Pub. No.: US 2007/0040348 A1
(43) Pub. Date: Feb. 22, 2007

(54) Expanded armed wheelchair

(76) Inventor: Debra Erickson, Twin Lake, MI (US)

Correspondence Address: Debra Erickson, 2586 E. River Road, Twin Lake, MI, 49457, US

(21) Appl. No.: 11/367,797

(22) Filed: Mar. 6, 2006

Related U.S. Application Data
(60) Provisional application No. 60/709,751, filed on Aug. 22, 2005.

(51) Int. Cl. B62M 1/14

(52) U.S. Cl. 280/250.1; 280/304.1

(57) ABSTRACT

A expandable arm wheelchair which is comprised of a wheelchair base (1) expandable arm (2) locking mechanism (3) Geared locking mechanism (4).

### CROSS REFERENCE TO RELATED APPLICATION

This application relates to and claims priority from U.S. Provisional Patent Application Ser. No. U.S. 60/709,751 filed Aug. 22, 2005, the specifications which are incorporated herein by reference.

### FEDERALLY SPONSORED RESEARCH

Not Applicable

### SEQUENCE LISTING OR PROGRAM

Not Applicable

### BACKGROUND OF INVENTION—FIELD OF INVENTION

Healthcare officials in the past have been using wheelchairs for quite some time however, with obese people, it has been quite a challenge for the healthcare industry. The wheelchairs in existence today do not accommodate obese people as well as they should. Furthermore, transportation with wheelchairs has and is, a challenge because the larger the occupant is, the wider the wheels have to be to accommodate the occupant because of the width of the occupant. To add, when a person with obesity has to be transported, the lift on a vehicle which does the transport, is unable to accommodate the width of the very wide wheelchair which in turn is caused from the width of the obese occupant. This new product Expandable Armed Wheelchair which will be referred to as “EAW” proves the EAW to be far superior to the U.S. Patent 20050248143 Sato Hisayoshi discloses a complex adjustable wheelchair but the problem for the obese user still exist with the current adjustable wheelchair. The issues with unloading and loading in transport vehicles of the obese user will still be a stigma. The problems which arise are the more obese the person or end user is the wider the wheel base on the wheelchair has to be. U.S. Patent 20050248143 Sato Hisayoshi does not address the issue of obese people like the EAW does. U.S. Patent 20050248143 Sato Hisayoshi does not address the issue of the heath care industry as far as moving obese clients in and out of vans as well as loading and unloading from transport vehicles. U.S. Patent 20050248143 Sato Hisayoshi does not look at the real problem that exist which is the wide wheel base on the present wheelchairs today.

To add, another problem is abundantly clear is the width of the door ways today. The more and more people continue to be inflicted by obesity the wider doorways need to be. Now there is two different issues here one being new construction with new codes and two the renovation of old construction to provide wider door ways. Now w/new codes and construction is not to much of a problem, however; it does merit being mentioned. Where a major problem exist is the fact that the larger and wider people continue to get renovation of commercial as well as residential building will indeed need to transpire. The “EAW” will help relieve the codes as well as the renovation of old commercial and residential buildings. For, with the “EAW” having the wheelbase remain the same instead of changing for the over whelming obesity problem we face today.
a. The wheelchairs used today for obese people do not fit through most doorways in old construction.
b. The wheelchairs used today for obese people are creating many new codes.
c. The wheelchairs used today for obese people are very hard to maneuver because of width of wheelbase.
d. The wheelchairs used today for obese people are unsafe because of wheel base trying to fit through door ways.
e. The wheelchairs used today for obese people are unsafe because of wheel base for unloading and loading on ramps of vehicles.

### BACKGROUND OF INVENTION—OBJECTS AND ADVANTAGES

Accordingly, besides the objects and advantages of the “EAW” described in my above patent, several objects and advantages of the present invention are:
A. The “EAW” will relieve the problem of the current wheelchairs in the width of old constructed door ways.
B. The “EAW” could relieve the ongoing code changing issues w/new and old construction wether residential or commercial.
C. The “EAW” will be much easier to maneuver because of shorter wheel base.
D. The “EAW” will be more safe as far as maneuvering obese people through doorways.
E. The “EAW” will be more safe for people loading and unloading from transport vehicles as well as the end user of the “EAW”.

### SUMMARY

In accordance with the present invention, the “EAW” comprises a locking mechanism, an expandable arm, a geared locking arm, padded side mechanism.

In the drawings, closely related figures have the same number but different numerical suffixes.

### DRAWINGS—FIGURES

FIG. 1(1) rear view illustrates the entire body and structure of a wheelchair.

FIG. 1(2) rear view illustrates the expandable arm.

FIG. 1(3) rear view illustrates the locking mechanism.

FIG. 1(4) Rear view Illustrates the geared locking Mechanism.

FIG. 2(1) side view illustrates the entire body and structure of a wheelchair.

FIG. 2(2) side view illustrates the expandable arm.

FIG. 2(3) side view illustrates the locking mechanism.

FIG. 2(4) side view Illustrates the geared locking Mechanism.

FIG. 3(1) top view illustrates the entire body and structure of a wheelchair.

FIG. 3(2) top view illustrates the expandable arm.

FIG. 3(3) top view illustrates the locking mechanism.

FIG. 3(4) top view Illustrates the geared locking Mechanism.

### DRAWINGS—Reference Numerals

1 wheelchair base
2 expandable arm
3 locking mechanism
4 geared locking arm

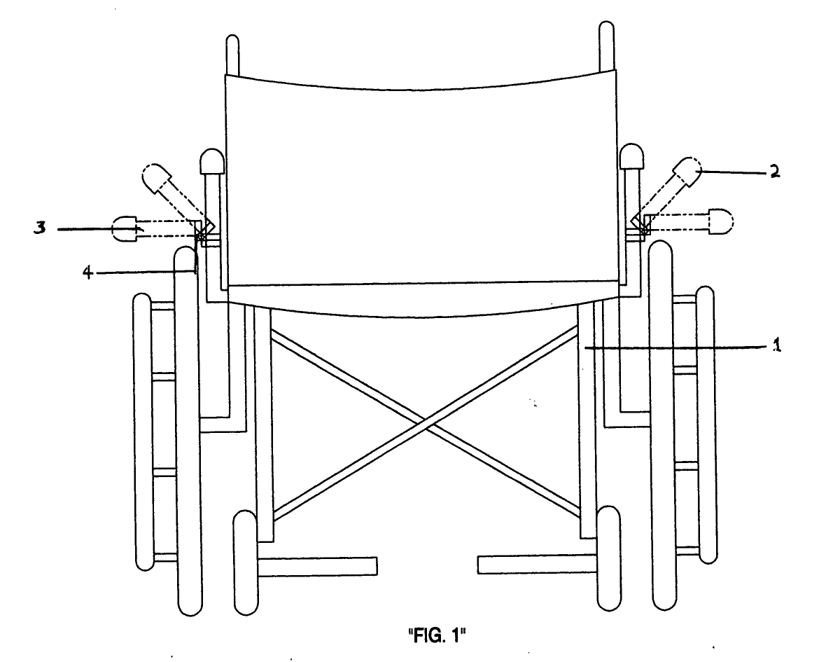

### DETAILED DESCRIPTION—FIGS. 1 THROUGH 3 PREFERRED EMBODIMENT

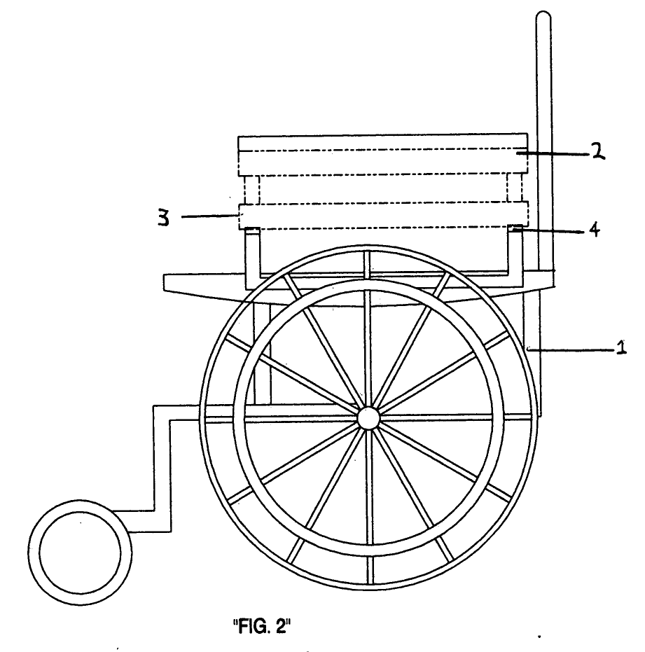

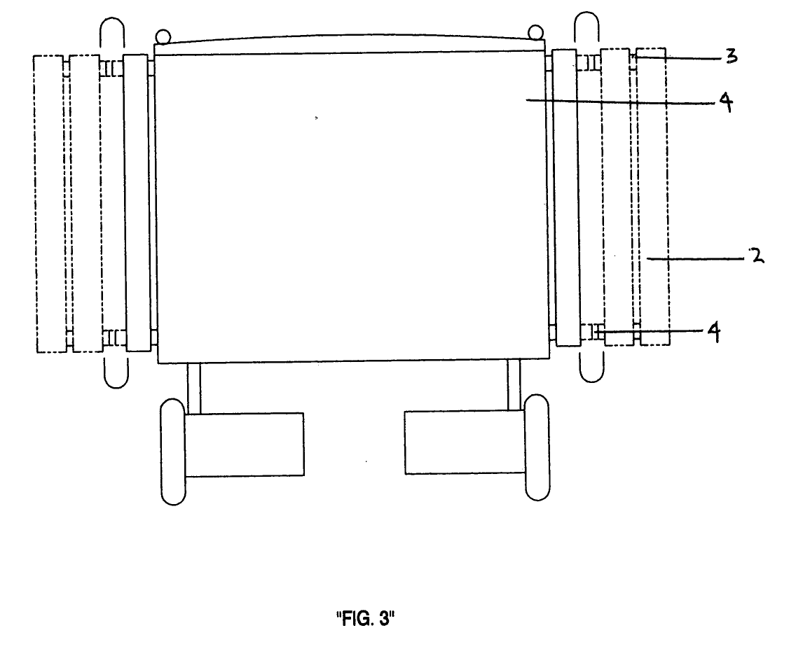

A preferred embodiment of the EAW present invention is illustrated in FIG. 1 (1) (rear view) illustrates the entire structure of the wheelchair 1 (2) illustrates the expandable arm of the wheelchair base FIG. 1(3) illustrates the locking mechanism fog1(4) illustrates the geared locking mechanism. FIG. 2 (1) side view illustrates the wheelchair base FIG. 2 (2) illustrates expandable arm of the wheelchair base FIG. 2 (3) illustrates locking mechanism FIG. 2 (4) illustrates the geared locking mechanism. FIG. 3(1) top view illustrates the wheel chair base FIG. 3 (2) illustrates the expandable arm mechanism of the wheelchair base FIG. 3 (3) illustrates the locking mechanism FIG. 3 (4) illustrates the geared locking mechanism.

The wheelchair base will have the expandable arm adhered to the locking mechanism which will embody the geared locking mechanism.

Advantages

From the description above a number of advantages of my EAW become evident.

(a) The “EAW” will relieve the problem of the current wheelchairs in the width of old constructed door ways.

(b) The “EAW” could relieve the ongoing code changing issues w/new and old construction wether residential or commercial.

(c) The “EAW” will be much easier to maneuver because of shorter wheel base.

(d) The “EAW” will be more safe as far as maneuvering obese people through doorways.

(e) The “EAW” will be more safe for people loading and unloading from transport vehicles as well as the end user of the “EAW”.

Accordingly, the reader will conclude that the EAW is more safe and far more superior way of moving as well as transporting the end user.

### CONCLUSION, RAMIFICATIONS, AND SCOPE

The “EAW” will relieve the problem of the current wheelchairs in the width of old constructed door ways.
The “EAW” could relieve the ongoing code changing issues w/new and old construction wether residential or commercial.
The “EAW” will be much easier to maneuver because of shorter wheel base.
The “EAW” will be more safe as far as maneuvering obese people through doorways.
The “EAW” will be more safe for people loading and unloading from transport vehicles as well as the end user of the “EAW”.

Although the product described above has many specifics, it does not limit the scope of the invention but merely providing illustrations through verbiage as well as drawings of some of the patent present embodiments.

We claim:

1. A method for expanding a wheelchair.
(i) Wheelchair base
(ii) Expandable arm
(iii) Locking mechanism
(iv) Geared locking mechanism

2. A wheelchair with the capabilities of expanding the arms with locking mechanisms.
(i) Wheelchair base
(ii) Expandable arm
(iii) Locking mechanism
(iv) Geared locking mechanism
